(19) United States
(12) Patent Application Publication
(10) Pub. No.: US 2008/0307094 A1
(43) Pub. Date: Dec. 11, 2008

(54) Association of peer-to-peer contribution credits with multiple devices

(76) Inventors: Olli Karonen, Helsinki (FI); Jukka K. Nurminen, Espoo (FI)

Correspondence Address: Hollingsworth & Funk, LLC, 8009 34th Avenue South, Suite 125, Minneapolis, MN, 54425, US

(21) Appl. No.: 11/811,498

(22) Filed: Jun. 11, 2007

(51) Int. Cl. G06F 15/173

(52) U.S. Cl. 709/226

(57) ABSTRACT

A first device is coupled to a peer-to-peer data processing network. Resources of the peer-to-peer data processing network are allocated based on credits, and the credits are earned based on contribution of resources to the peer-to-peer data processing network. An association is created between the first device and the second device, and data describing the association is accessible via the peer-to-peer data processing network. First credits are accumulated via the first device based on first resources contributed to the peer-to-peer data processing network by the first device. The second device is coupled to the peer-to-peer data processing network. The second device then accesses the resources of the peer-to-peer processing data network utilizing the first credits based on the association between the first device and the second device.

### FIELD OF THE INVENTION

This invention relates in general to remote access of networks, and more particularly to credit-based access to peer-to-peer networks.

### BACKGROUND OF THE INVENTION

Peer-to-peer (P2P) systems generally refers to networked collections of computers that are capable of forming ad-hoc relations with each other in order to engage in a particular activity, often without relying on any particular fixed service or infrastructure. The term “P2P” can be applied to many aspects of self-forming network, including the establishing physical and logical connectivity, routing data, and utilizing data available from peers on the network. The latter type of P2P systems includes Internet P2P file sharing, as exemplified by technologies such as Gnutella and BitTorrent.

Peer-to-peer file sharing activities generate a significant amount of Internet traffic. Although P2P file sharing is sometimes associated with sharing of content between individuals, some content creators and stakeholders realize that the efficiencies inherent in P2P file sharing may make it useful for business purposes as well. One attractive aspect of P2P technologies is that it allows discovery of other users sharing in similar interests. For example, if a person discovers another user that has similar musical tastes, that person may discover new material in line with those tastes by perusing the offerings of that other user. Other aspects of P2P technologies are designed to efficiently use network resources in distributing large amounts of data. In particular, technologies such as BitTorrent can distribute downloads between large numbers of individual nodes and relieve bottlenecks inherent in downloading from centralized servers.

A P2P community may include commercial entities, groups, and individual users. Devices that engage in P2P activity may include fixed network servers, personal computers (PC), mobile devices, etc. Many different kinds of content may be accessed or distributed by P2P, including files (e.g., media content, software) and streaming data. There is a great opportunity for mobile P2P applications and services to share or even exceed the success seen with PC-centric P2P, because mobile clients can immediately benefit from the existing communities and technologies on the fixed side, and, at the same time, offer value and services that are unique to mobile/ubiquitous computing.

In general, a successful P2P community relies on the capacity offered by the peers themselves. This capacity may be measured in terms of content and/or bandwidth that is offered or contributed to the P2P network. It is recognized that P2P systems may not work adequately if there are too many “free riders” who do not contribute to compensate the additional load they generate. In order to ensure that the benefits of P2P are provided in proportion to the contributions, some P2P systems implement credit systems.

A highly popular P2P file sharing system known as “Kazaa” implements a P2P credit system. Every Kazaa user is given a participation level (PL) during use, varying between 0 and 1000, and depending on the ratio between recent uploads and downloads. Higher PL compared to other peers simply means more priority during downloading in the event of competing requests. Although generally effective, this particular system can be defeated in a number of ways. For example, the PL stored in memory can be increased using a memory editor.

Currently, other popular P2P systems like BitTorrent and eMule use a similar credit system to that of Kazaa. While they are more robust against tampering, most of the limitations of Kazaa still remain. For example, these credit systems only account for contributions during the current session. Thus there is no motivation for users to remain connected to the network to provide further upload contributions after downloading is complete. In another example, BitTorrent allocates credits based on a particular file, and does not apply credits earned for file download to another download.

Mobile devices are at a disadvantage when trying to take advantage of P2P credit schemes. Such devices may not be able to serve up large amounts of data because of limited storage on such devices. Even when a device can make a significant data contribution, limited battery life can make it undesirable to provide a contribution while in a standby mode. For these and other reasons, it may be unlikely a user would want to stay connected to a P2P network any longer than needed, even if P2P credits could be earned for staying connected. However, P2P networks can provide numerous benefits to mobile computing applications, and therefore, a way of allowing a mobile device to better utilize P2P crediting schemes is desirable.

### SUMMARY OF THE INVENTION

To overcome limitations in the prior art described above, and to overcome other limitations that will become apparent upon reading and understanding the present specification, the present invention discloses a system, apparatus and method for associating peer contribution credits with multiple devices. In accordance with one embodiment of the invention, a method involves coupling a first device to a peer-to-peer data processing network. Resources of the peer-to-peer data processing network are allocated based on credits, and the credits are earned based on contribution of resources to the peer-to-peer data processing network. An association is created between the first device and the second device. Data used in enforcing the association is accessible via the peer-to-peer data processing network. First credits are accumulated via the first device based on first resources contributed to the peer-to-peer data processing network by the first device. The second device is coupled to the peer-to-peer data processing network, and the resources of the peer-to-peer processing data network are accessed by the second device utilizing the first credits based on the association between the first device and the second device.

In more particular environments, the method further involves communicating the association between the first device and the second device to peers of the peer-to-peer data processing network. The association between the first and second devices may include common ownership of the first and second devices. In one arrangement, the first device includes a non-mobile device and the second device includes a mobile device.

In more particular environments, the association between the first and second devices involves an transfer of valuable consideration from an owner of the second device to an owner of the first device. The transfer of valuable consideration may include a monetary transfer, and/or acceptance of advertisement by the owner of the second device. In one arrangement, a central entity. In another arrangement, peers of the peer-to-peer data processing network that were not involved in the access of the resources by the second device track the accumulated credits.

In more particular environments, the peer-to-peer data processing network includes a distributed data distribution network, and the contribution of resources to the peer-to-peer data processing network involves transfers of data from peers of the peer-to-peer data processing network to other peers of the peer-to-peer data processing network. In such a case, the contribution of resources to the peer-to-peer data processing network may also include transcoding of media on behalf of the other peers of the peer-to-peer data processing network. In one arrangement, the peer-to-peer data processing network includes a distributed search network, and the contribution of resources to the peer-to-peer data processing network includes a quantity of uploadable items made searchable by peers of the peer-to-peer data processing network. In another arrangement, the contribution of resources to the peer-to-peer data processing network further includes a quantity of the uploadable items uploaded to peers of the peer-to-peer data processing network. In another arrangement, the contribution of resources to the peer-to-peer data processing network comprises transcoding of media on behalf of other peers of the peer-to-peer data processing network.

In another embodiment of the invention, an apparatus includes a network interface capable of communicating via a peer-to-peer data processing network, wherein resources of the peer-to-peer processing network are allocated based on credits, and wherein the credits are earned based on contribution of resources to the peer-to-peer data processing network. A processor is coupled to the network interface, and memory is coupled to the processor. The memory including instructions that cause the processor to connect to the peer-to-peer data processing network and determine an association between the apparatus and a peer device of the peer-to-peer data processing network. The instructions further cause the processor to utilize credits of the peer device to access resources of the peer-to-peer processing network. The credits are made available based on the association between the apparatus and the peer device.

In more particular environments, the memory includes instructions that cause the processor to facilitate transfer of valuable consideration between an owner of the apparatus and an owner of the peer device. The association is created based on the transfer of valuable consideration. The association between the apparatus and a peer device may include common ownership of the apparatus and the peer device. The apparatus may include a mobile device and the peer device may include a non-mobile computing device. The apparatus may facilitate allowing peers of the peer-to-peer network to confirm the association.

In another embodiment of the invention, a computer-readable storage medium has instructions stored thereon which are executable by an apparatus capable of being coupled to a peer-to-peer data processing network. Resources of the peer-to-peer processing network are allocated based on credits, and the credits are earned based on contribution of resources to the peer-to-peer data processing network. The instructions are executable for performing steps including a) connecting to the peer-to-peer data processing network; b) asserting an association between the apparatus and a peer device of the peer-to-peer data processing network; and c) utilizing credits of the peer device to access resources of the peer-to-peer processing network. The credits are made available based on the association between the apparatus and the peer device.

In another embodiment of the invention, a system includes means for tracking credits assigned to peers of a peer-to-peer data processing network. The credits are earned based on contribution of resources to the peer-to-peer data processing network. The system also includes a first peer device capable of being coupled to the peer-to-peer data processing network. The first peer device include means for accumulating first credits based on first resources contributed to the peer-to-peer data processing network by the first peer device. The system also includes a second peer device capable of being coupled to the peer-to-peer data processing network. The second peer device includes means for utilizing the first credits based on an association between the first peer device and the second peer device. The system further includes means for persistently storing association data that describes the association between the first peer device and the second peer device, and means for making the association data available to the peers of the peer-to-peer data processing network. In a more particular embodiment, the system further includes means for transferring valuable consideration from an owner of the second device to an owner of the first device. The association data is created based on the transfer of the valuable consideration.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIG. 2 is a block diagram illustrating associated devices in a system according to an embodiment of the invention;

FIG. 3 is a block diagram illustrating a P2P credit transaction between two devices according to an embodiment of the invention;

FIG. 4 is a block diagram illustrating a P2P credit transaction between two user level accounts according to an embodiment of the invention;

FIG. 5 is a block diagram illustrating a P2P credit pooling arrangement between users and devices according to an embodiment of the invention;

FIG. 6 is a block diagram of distributed credit tracking according to an embodiment of the invention;

FIG. 7 is block diagram of a mobile computing arrangement according to an embodiment of the invention;

FIG. 8 is block diagram of a credit server arrangement according to an embodiment of the invention; and

FIG. 9 is a flowchart illustrating using P2P credits according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

The present disclosure is directed to a credit system that enforces a “give in order to receive” requirement to induce active participation in peer-to-peer (P2P) services and applications. The present invention may be applicable to different type of P2P networks, and in particular P2P networks that rely on sharing computation and/or data processing tasks. An example of such a system described in the present disclosure is a P2P file sharing system. Such a file sharing system may involve any combination of distributed search and distributed file transfer. File sharing systems such as Kazaa, Gnutella, Morpheus and Freenet, allow searches to be quickly distributed among peers. The search results list available files or other data objects available for download via peer machines. Generally, a directory of the client is designated as shared, and the locally running P2P program queries data in the shared directory when responding to search requests from others.

A client can initiate a data download from one or more of the peers, typically in response to a successful search query. The search results may include a measure of the network speed (e.g., dial-up, DSL, cable, T1, etc.) of the peer machine that is offering a download. In some implementations, different segments of the same file can be downloaded from multiple peers simultaneously, thereby speeding up the download and reducing load on individual peers.

In contrast, a protocol such as BitTorrent does not rely on a distributed search feature, but is directed to widely distributing downloads of a particular (usually large) file. Users typically download a “torrent” file that may be located using traditional Internet search techniques. The torrent file contains metadata about the files to be shared and a centralized computing node (known as a “tracker”) that coordinates distribution of the shared file. In some so-called “trackerless” systems, every peer acts as a tracker, thus negating the need for a centralized computer to handling coordination duties. In either case, a peer acts as both a client, downloading parts of the target file from (preferably) multiple peers, and a server, offering parts of the file already downloaded to other peers. After the downloading is complete, the user is asked to keep the client running and thereby continue to contribute to the torrent.

A P2P credit system helps promote user contributions to the P2P, thus ensuring the network has enough shared resources to remain viable. This problem is a variant of the Prisoner's Dilemma in game theory, which posits a situation where two players have a choice between cooperating with the other player or defecting (betraying) the other player. Although the greatest gain is seen where both players cooperate, the greatest loss is seen by one player who cooperates at the same time that the other player defects. It is found that rational players will both choose to defect rather than cooperate in order to minimize losses, even though mutual cooperation would provide superior gains to both. In the realm of P2P, “defecting” relates to freeriding and “cooperating” relates to contribution. Even though contributions to the network will benefit the contributor as a whole (e.g., the contribution will make the network more attractive to other users who will join and contribute) fears about sharing files (e.g., security, bandwidth usage) may cause users to minimize short term risk and not contribute. The hesitance to contribute can be mitigated by providing contribution credits that can be used to enhance the usability of the network.

The implementation of crediting systems allows users participate in P2P communities as “good citizens.” That means that users should not only take advantage of the resources provided by other peers, but also contribute resources to the community themselves. The resources provided and consumed by peers of the network community are typically specific to a particular type of P2P network, and may include downloads/uploads of data, network bandwidth, shared processing, distributed transcoding, distributed storage/memory, and any other computing function/capability that may be shared across a network. Typically, the resources that are shared and consumed are the same (e.g., tit-for-tat exchange of resources) but non-like kind exchanges may be used as well.

Many P2P communities have introduced technical solutions to enforce the “tit-for-tat” principle. However, for mobile devices, it is sometimes difficult to contribute to a P2P network at the same time as consuming content from the network. This is especially true when the mobile device is outside of a wireless local area networks (WLAN) (or other low-cost, high-bandwidth network), and must rely on lower-bandwidth, higher-cost cellular networks. Factors that inhibit mobile device P2P contributions wireless contributions in such situations include uplink bandwidth that is much less that downlink bandwidth, limited processing and networking bandwidth in general, limited persistent and non-persistent memory, limited battery life, etc. People are increasingly using mobile devices as their primary communications tool, and without providing some way for a mobile device user to contribute to P2P networks, the usefulness of such networks will diminish.

Current P2P credit systems have been designed primarily for PC-based file sharing, and the design tradeoffs made in those credit systems reflect a PC-centric view of content consumption. For example, the “tit-for-tat” strategy used by BitTorrent suffers from ramp up delay because a user must first earn credits before the user's service gains a desirable amount of bandwidth. However, no credits can be earned until at least some material is downloaded, stored, made available for upload, and credit balances updated. As a result, BitTorrent is too slow in the starting phases, especially for live content. Further, the BitTorrent system lacks memory, thus a download associated with a current torrent file can not take advantage of previous contributions to other torrents. However, if a BitTorrent-type system uses some sort of persistent credit, it is possible to use the already accumulated or in-parallel acquired credits to get a fast start immediately.

Although examples presented herein may be directed to file sharing P2P systems, the present invention may be applicable to any type of network communications where greater access to network resources is provided in proportion to resource contributed to the network. For example, a self-forming mesh network provides flexible and reliable point-to-point routing by passing data between adjacent nodes which are each capable of routing data. Such nodes contribute to network connectivity, thus may be rewarded in like kind, such as being given increased priority, quality-of-service, bandwidth allowance, etc., for connections in which the node is an active participant.

Another example of a P2P system that may use a credit system according to an embodiment of the invention is a distributed data processing system. Such distributed processors may perform small, distributed computations or large, centralized computations. An example of a small distributed solution is distributed transcoding. Transcoding involves digital-to-digital conversion of data, usually digital media. The use of transcoding is particularly prevalent in the mobile environment due to the diversity of mobile devices. Although transcoding can be handled well on modern desktops, it can still be taxing to the low-power processors seen on mobile devices. One solution is to distribute the transcoding tasks to peer devices that may be idle at the time.

Peer-to-peer (P2P) transcoding involves a user device downloading a media file/stream, either from a peer of a P2P network, server, or other source. The downloading device determines the media format in which his device supports and the format of the media to be downloaded. If the original media is in wrong format, one or more peers of the P2P network transcode the content to the requested format. In the context of the present invention, the peers who are willing to do transcoding may earn extra credits, and may earn those credits from multiple devices. In this way users can earn additional transcoding credits with their PC and then use these credits on their mobile devices. Earning extra credits by transcoding of media can be used to promote the transcoding. Thus, a system of mobile devices can share transcoding tasks, with idle devices contributing processor time, and later receiving in-kind transcoding assistance.

In other application environments, distributed processing systems are used to solve large computational tasks that are amendable to being divided into subtasks, the solutions of which can later be combined into a full solution. An example of solving a centralized task includes public resource computing projects such as SETI@home. SETI@home utilizes idle Internet-connected computers to perform signal analysis of radio telescope data. In this and similar systems, the computation is divided into discrete work units which are dispatched to client programs running on idle processors. The results of the work unit calculations can be collected at a later time by a controller and combined into a larger solution. In such a centralized computing task, there may be fewer scenarios where individual contributors of idle processor time may want reciprocal use of other processors. Nonetheless, such a system may track credits for some combination of like-kind and/or alternate benefits from the P2P processing contributions.

Even though public resource computing projects and the like may be less likely to offer reciprocal computing credits, they do offer credits in the form of ranking and/or recognition. In some cases, this ranking or recognition may have value, such as providing exposure to a cause (e.g., save the rainforests). Therefore, in ranking/recognition type awards systems, users could still transfer credits amongst one another in exchange for value, or donate credits to one another. Such award type credits could give a person or entity more or fewer votes and/or influence. Such votes/influence may be used on the public resource project or other project, for example, when giving recommendations, when requesting new features on an open source project, obtaining membership status, etc.

Most current P2P credit systems are based on pairwise crediting. Peer A knows how good service it has received from peer B but peer C is not able to access this information. The “credit” earned by B when serving A cannot be used to get services from C. Some systems, such as Kazaa provide for a “global” credit, e.g., one that accounts for all activity of a user, and not just pair-wise activities. However, the Kazaa system stores the credits locally, and this makes it easy to defeat the system. Other proposed system may use credits stored at a remote server to prevent credit cheating. Such systems may use cryptography to ensure the integrity of the data, and the system may introduce a memory with gradually decreasing credits as a function of time. This may hold some advantages for mobile devices. For example, credits can be earned beforehand by uploading content when the mobile device is being charged at night, assuming there is some demand for the content at that time.

However, such centralized tracking systems still accumulate credits based on a particular device. This is disadvantageous to mobile device users, because such devices may be constrained from providing contributions due to power limitations, bandwidth costs, etc. In such a case, it would be more useful if the credits could be tied to two or more devices. One of the devices may be a non-mobile device that can be always left on and be connected to a public network, such as a home computer with a broadband connection to the Internet. The other device may be a mobile device that is always with the user. The user may be more likely to utilize the services from the mobile device, so the system allows the credits accumulated with the home computer to be applied to the mobile device.

The current solutions that allow peers with mobile phones to offer P2P capacity are often deficient when sharing big files or streaming live or recorded videos. The systems, apparatus, and methods described herein allow a group of devices (such as a home computer and a mobile phone) to share the same P2P credit account. Credits earned with one device (e.g., home computer) can be consumed by another device (e.g., mobile phone). This allows mobile devices to consume content from the communities while at the same time ensuring that enough devices are providing resources to the community. Even though current P2P implementations may lack this type of credit tracking capability, it is possible to implement the credit sharing arrangements as an extension to the existing solutions so that peers that do not currently support the system would still be able to work. However, in such a case services provided or used by the non-compatible devices would not affect a shared credit balance. For best results it would be desirable that a majority of the peers support the system.

A P2P community may consist of any combination of user groups, individual users, PCs, mobiles, and different kinds of content. In some arrangements, P2P credits can be shared at any combination of device, user and user group levels. This extension of credit-based system is desirable in order to have mobile P2P users to obtain improved service levels and contribute to the community, despite limitations inherent in mobile devices and/or mobile networks. A user can earn credits among various devices, and share credits among those same devices. User groups can do the same among between their members. A user can be a private person or a company offering P2P-based services. Credit sharing can be mutual, based on trading (e.g., using virtual or real money), and/or based on donation.

When such a credit system is implemented, a user can connect his PC to the P2P network to generate credits, and this allows the user's mobile to get better service from the community (e.g. to start downloading immediately and with high priority). This incentive for the users to provide resources to the community using alternate means ensures that the performance of the community does not deteriorate when an increasing number of mobile peers join. One powerful personal computer may also allow several other mobile clients (even free riders) to use the P2P system, while at the same the overall performance of the P2P system remains the same or even improves. In some arrangements, the amount of credits earned can be increased by providing special services. User can offer additional services on his PC, like transcoding original content to different resolution, to gain more credits. This acts as an incentive to provide resources for special services and can speed up the introduction of such features.

Many P2P communities (e.g., Kazaa) benefit from high capacity supernodes that are mostly focused on serving the other peers. Currently there is little incentive to for the peer to become a supernode. But with the credit collection allowed by the invention the supernode would a useful mechanism to collect credits (which can be used for his mobile use or even for trading or other purposes). Devices with different capabilities (e.g. for different network access) could pool their credits together for ad hoc purposes. For instance, two or more users in proximity and with limited (cellular) bandwidth, some of them having high and others too low credits, can join pool their credits and use e.g. ad-hoc WLAN in local sharing. This may be less effective, however, if base station bandwidth is the main bottleneck.

In another example, the user's preferred multimedia consumption device (e.g. a PC) is in his bedroom, but is noisy so the user prefers to turn it off when not in use. A different PC in another room, or a silent mobile phone in the same room, can be used to earn credits during nights or whenever the noise is an issue. Those credits can be consumed with the user's primary device, for example, to receive streaming content from the P2P community. In another example, users can buy (e.g., using virtual or real money) credits from other users who have made contributions to the P2P network, rather than having to contribute to the network themselves. Similarly a commercial entity or service provider can buy credits from the users and sell credits to users. A commercial company or service provider can offer credits to the users for free (e.g., if the primary business model is based on advertising, the credits can be received in exchange for viewing advertising). In another example, a company could add several computers to the P2P network to perform services needed by mobile peers (e.g. transcoding). The credits earned by the company could be given as gifts to the purchasers of new multimedia phones.

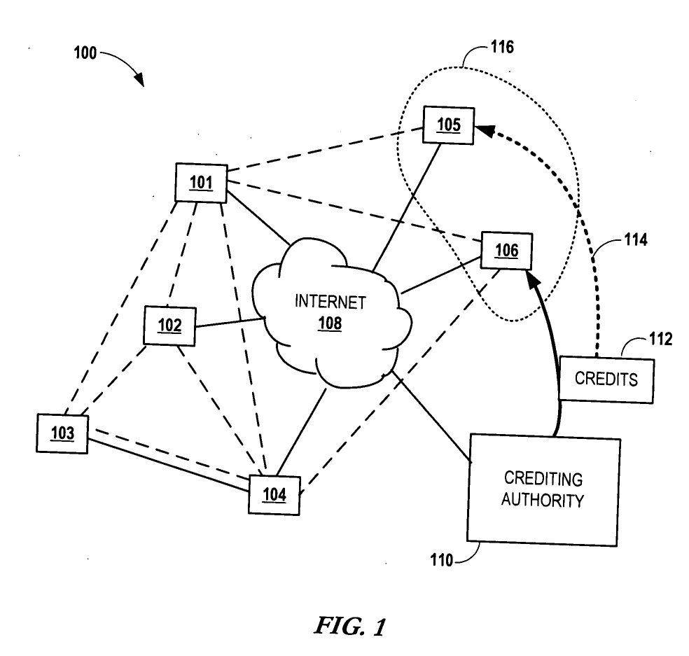

In reference now to FIG. 1, a system diagram illustrates an example P2P network 100 according to an embodiment of the invention. Generally, a plurality of networkable computing device 101-106 are coupled to a network such as the Internet 108. The devices 101-106 may have direct Internet Protocol (IP) access to the Internet 108, and/or some of them may use a non-IP protocol. In the latter case, another device may provide the network access on behalf of the non-networkable device (e.g., device 103 may not have IP access, but may be able to engage in network transactions by way of device 104). As indicated by the dashed lines, devices 101-106 may have multiple virtual connections with others of the devices 101-106, and these virtual connections may form the P2P network 100.

Generally, the P2P network 100 provides access to the nodes 101-106 in proportion to contributions made by the nodes 101-106. The access/contributions can be any manner of data processing activity including upload/download capacity, network data transfer, and/or computations. The P2P network includes a crediting authority 110 that ensures the accurate assignment of credits on the network 100 to nodes 101-106 that have made contributions. In return, the nodes 101-106 can use the credits to gain access or have improved access to network resources. The crediting authority 110 may be a dedicated computing entity (e.g., a server), a trusted element of one or more of the nodes 101-106, or distributed protocol that causes the credit data to be distributed among all of the nodes 101-106 so that a node acting alone cannot alter the credit data, in particular its own credit data, without proper authentication.

The credits transferred by the nodes 101-106 and/or authority 110 may have equal value across the entire network 100, or there may be different categories of credits that have different uses and relative values. For example, there may be different contribution categories where an end user may receive more valuable credits (or get relatively more credits) if that user offers certain types of contributions. This may enable a type of “spot market” for contributors and consumers. Generally, a credit may be any time of representative data that entitles the owner of the credit to something of value on the network 100.

In the illustrated example, the authority 110 issues credits 112 to node 106 based on the node's contribution to the network 100. However, the credits 112 are also made available for use by node 105 (as indicated by path 114) because of an association 116 existing between nodes 105, 106. This association 116 may be a pre-existing relationship (e.g., common ownership) that existed before the credits 112, or the association 116 could be formed and used after the credits 112 are awarded. The association 116 may require that at least the donating node 106 acknowledge the relationship, and it may be up to the donee node 105 to assert the relationship when using the credits 112.

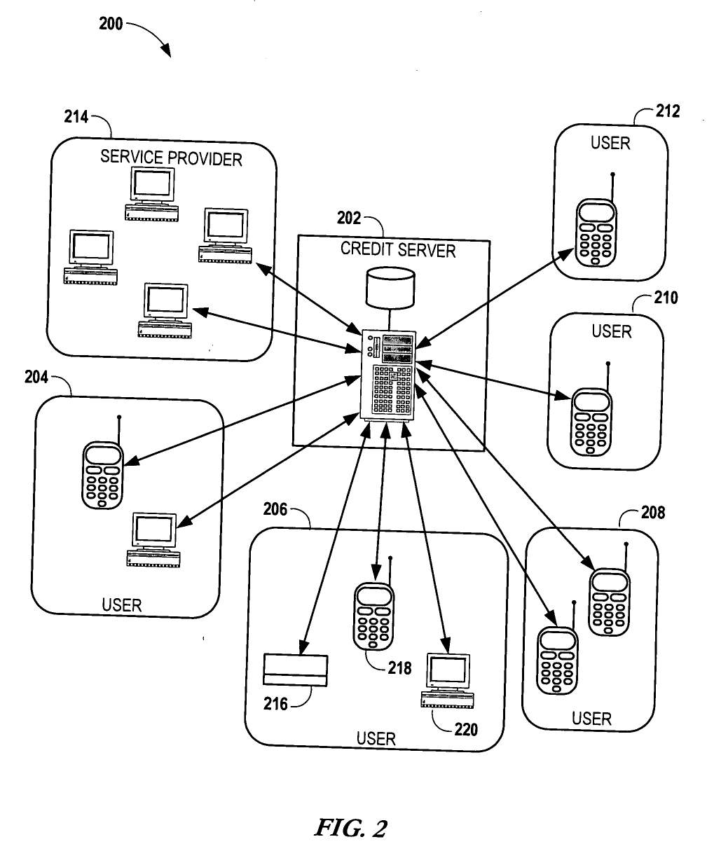

In reference now to FIG. 2, a diagram 200 illustrates a peer-to-peer networking system according to an embodiment of the invention. Generally, a credit server 202 contains a database of credit accounts of users, user groups, or any other entities that may provide and/or use credits of the networking system 200. Various device of the network 200 may have preconfigured associations into device groups, as exemplified by users 204, 206, 208, 210, and 212. Another type of entity that may be associated with a number of devices is represented as service provider 214. The service provider 214 may not need or desire the ability to use credits on the network 200, although the credit provider 214 may be able to accumulate credits in the usual way, e.g., by contributing resources to the network 200.

The service provider 214 may include one or more machines that can transfer credits to other network entities, including devices of users 204, 206, 208, 210, 212. This transfer of credits may be in exchange for some valuable consideration (e.g., monetary or non-monetary instruments/credits) or service (e.g., viewing ads provided via service provider 214). The service provider 214 may be associated with the credit server 202, such as being the entity that creates and tracks credits on behalf of the network 200. Alternatively the service provider 214 may operate independently, accumulating credits just like any other user, and engaging in organized or ad hoc interactions with other users 204, 206, 208, 210, 212 in order to exchange the credits for something of use to the provider 214.

Generally, any of the users 204, 206, 208, 210, 212 can transfer credits to other users by using credit transfer mechanisms of the system. Another scenario involves the sharing of credits between devices owned by the same user. For example, user 206 has three computing devices capable of interacting over the network, a set-top box 216, a mobile handset 218, and a home computer 220. These devices 216, 218, 220 may perform any combination of utilization and/or contribution to the network 200. Any credits accumulated by the devices 216, 218, 220 may be used by others of the devices 216, 218, 220 based on the devices 216, 218, 220 being commonly associated with user 206.

The association between the devices 216, 218, 220 and the user 206 for credit access may be accomplished in a number of ways. For example the credit server 202 may associate credits with users, and require any accumulation or use of credits to be authenticated solely based on user identity. Such a system could be made independent of the device used, because the credits are tracked purely on a per-user basis. In another arrangement, the credit server 202 may explicitly associate the user 206 with particular devices 216, 218, and 220, and the credits used or accumulated by any of the devices 216, 218, 220 are automatically added to or subtracted from the same user's account by the credit server 202. In yet another arrangement, the devices 216, 218, 220 may be set up to be explicitly associated with each other, independent of a particular user 206, in order share credits from one another. In such a case, one device devices 216, 218, 220 (donee) that wants to use another's credit may assert a relationship with another of the devices 216, 218, 220 (donor), and the donor is queried in order to authenticate the transfer of the credits.

These examples of association between devices in order to commonly accumulate and use credits is exemplary, and those skilled in the art will appreciate that many variations may be devised based on the desired end result. For example, a user-only authentication approach is convenient for users such as travelers who may want to access the network 200 from equipment they do not own (e.g., public terminals at airports, hotels, etc.). However, it the user's authentication data is lost, there is no way to prevent any other person from using the credits. Device-dependent associations can relieve the user from having to maintain and safeguard identity data. However, in systems using device-based authentications, precautions must be to prevent spoofing of device identity. For example, although a media access control (MAC) address is an identifier that may uniquely identify a network device, it is very easy to spoof MAC addresses, and as such hardware identifiers such MAC addresses may not, by themselves, provide sufficient authentication. In such arrangements, the devices may be pre-configured with a secret key (or other secure authenticating device) that can be used in a challenge-response interaction that authenticates one or more devices. Such a secret key can be associated with one device or a group of devices, yet need not be associated with a particular user identity. The key could also be combined with particular hardware identifiers (e.g., similar to the combination of public with private keys) to ensure the keys are only usable with selected hardware.

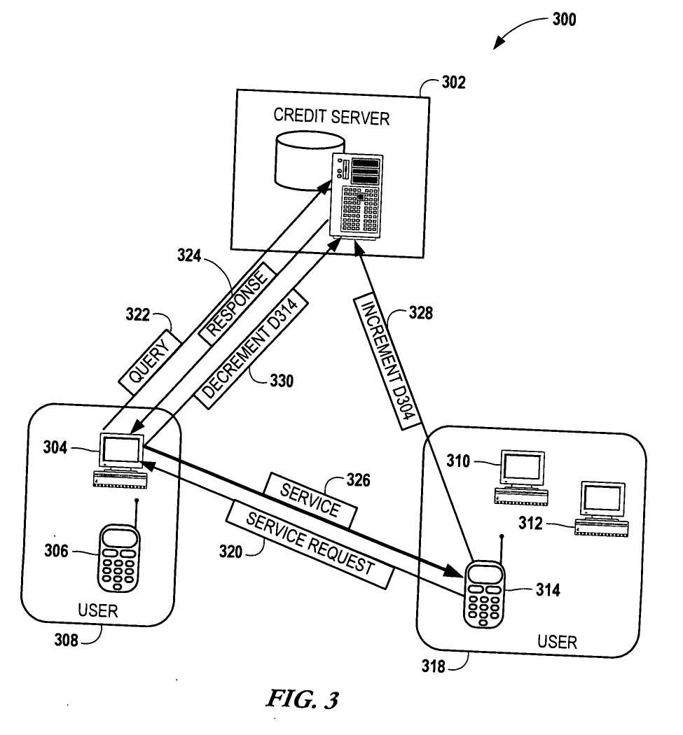

In reference now to FIG. 3, a block diagram illustrates transactions for using P2P credits in a P2P network 300 according to an embodiment of the invention. A credit server 302 mediates credit transactions on a P2P network 300. The network 300 includes devices 304, 306 associated with user 308, and devices 310, 312, 314 associated with user 318. Credits that are earned/consumed by users 308, 318 and/or devices 304, 306, 310, 312, 314 are tracked via the credit server 302. In the illustrated example, device 304 receives a service request 320 from peer device 314. In response, device 304 queries 322 credit server 302. The query 322 may contain an identifier of one or both of device 314 and user 318 that are requesting the service. The credit server 302 returns a response 324 indicating the credit balance of user 318 and/or device 314. Depending on the amount of credits indicated in the response 324, the computer 304 may choose to serve or not serve the requesting device 314, and/or the level of service will be adjusted based on the credits.

Assuming that the device 304 elects to provide the service (indicated by service path 326), the device 314 sends a message 328 to the credit server 302 that tells the server 302 to increment credits of device 304 and/or user 308 by the amount and quality of the received service 326. The provision of service 326 by computer 304 may be conditioned on device 314 communicating some acknowledgement to the credit server 302 that device 304 is offering the service 326. The server 302 which would then inform the computer 304 of this acknowledgment, and computer 304 would then begin/continue/complete the transaction based on the acknowledgement. The increment 328 of credits may occur before, during, or after the actual service 326 is provided. However, it may be desirable for the device/user providing the service 326 to have some positive indication that they are at least provisionally receiving credit for the service 326, although the actual credit increase 328 may rely on completion of the service 326 at the expected quality.

Because device 314 is receiving the benefits of the service 326, the computer 304 may also send a message 330 to the credit server 302 to indicate that device 314 and/or user 318 is using credits, therefore the amount of credits assigned to that user/device 318/314 is decremented 330. As with the increment of credits 328, the decrement 330 may have multiple steps. However in this case, the device 314 that receives the service may want to verify the decrement 330 after the service 326 is complete, because it is at that time that the device 314 can judge whether the service 326 satisfied the credit criteria.

In the above examples, the peer devices 304, 314 engaging in the service independently verify some aspect of the credit changes 328, 330 related to the service transaction 326. However, the server 302 may also provide some or all of the credit verifications. For example, the server 302 may consider both increment 328 and decrement 330 operations as provisional, and not enter either change 328, 330 if the quantities don't match. Such a check may be need to prevent cheating by ensuring no net increase or decrease in total system credits for any in-band transaction. If the crediting system uses “zero sum” crediting, the increment and decrement amounts should always be the same. Other scenarios may allow for non-zero-sum transactions, such as to favor particular users, devices, locations, or actions, and one or both of the increment and decrement amounts may be adjusted before performing a zero sum comparison. Assuming the operations 328, 330 satisfy the conditions of the system, the changes are then applied to a credit database by the server 302. Although the operations shown in FIG. 3 utilize a commonly accessible credit server entity 302, some or all of the credit operations can be performed in a distributed P2P fashion as will be described in greater detail elsewhere herein.

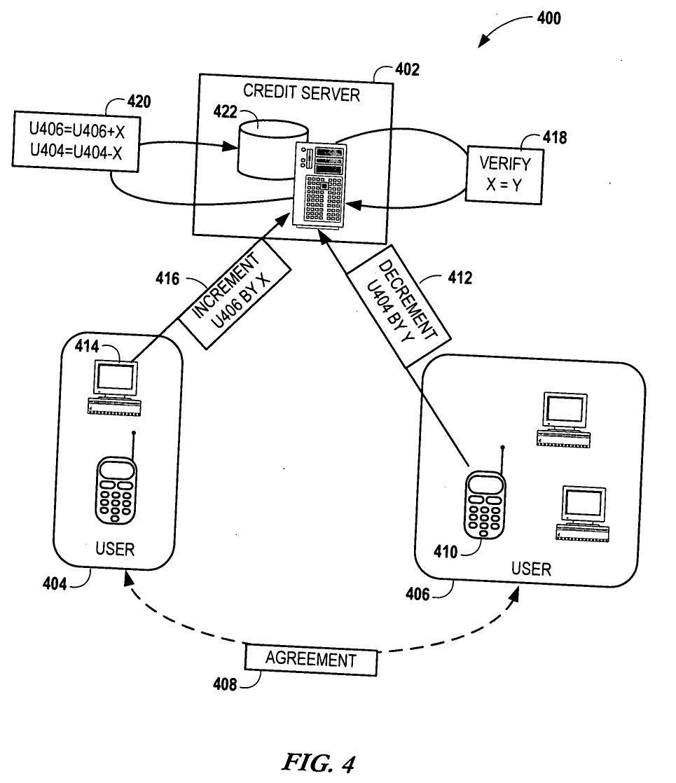

In the example scenario of FIG. 3, credits are earned and consumed are through the providing and use of a network service (e.g., data download, service offerings). However, other ways of changing credits may also implemented in systems according the invention. One example is shown in FIG. 4, which illustrates an “out-of-band” credit transfer on a P2P network 400 according to an embodiment of the invention. In this context, the term “out-of-band” is used to describe the adding and subtracting of a user's credit for some other purpose than for which the credits are primarily intended to be used. For example, where credits are used for access and/or service quality, an “in-band” transfer involve credits are added or subtracted based on access and/or service quality provided. However, an out-of-band transfer may occur for other reasons, such as a donation or exchange for valuable consideration.

In the network 400, a credit server 402 acts as an authority for tracking credits, although as with other scenarios, a distributed credit tracking scheme may also be used. Two users 404, 406 are members of the network, and each member 404, 406 may have multiple devices that are associated with each other for purposes of commonly accumulating and spending credits. In this example, users 404, 406 have entered into an out-of-band agreement 408 where user 404 transfers credits to user 406. User 406 may buy the credits, user 404 may just donate credits to user 406, or some other arrangement may be agreed to. The present scenario is independent of the particular form of the agreement 408 or mechanisms used create or enforce the agreement 408.

In response to the agreement 408, a device 410 of user 406 is used to inform (412) the credit server 402 to decrement the credit for user 404 by the agreed upon amount. Also in response to the agreement 408, device 414 of user 404 instructs (416) credit server 402 to increment the credit of user 406 by the amount agreed to in the deal. The credit server 402 verifies (418) that quantities suggested 412, 416 by users 404, 406 match. If the quantities are successfully verified 418, the server 402 updates (420) a credit database 422. The zero sum verification 418 prevents cheating by collaboration, and can be used to ensure the desired level of scarcity/availability of credits within the network 400.

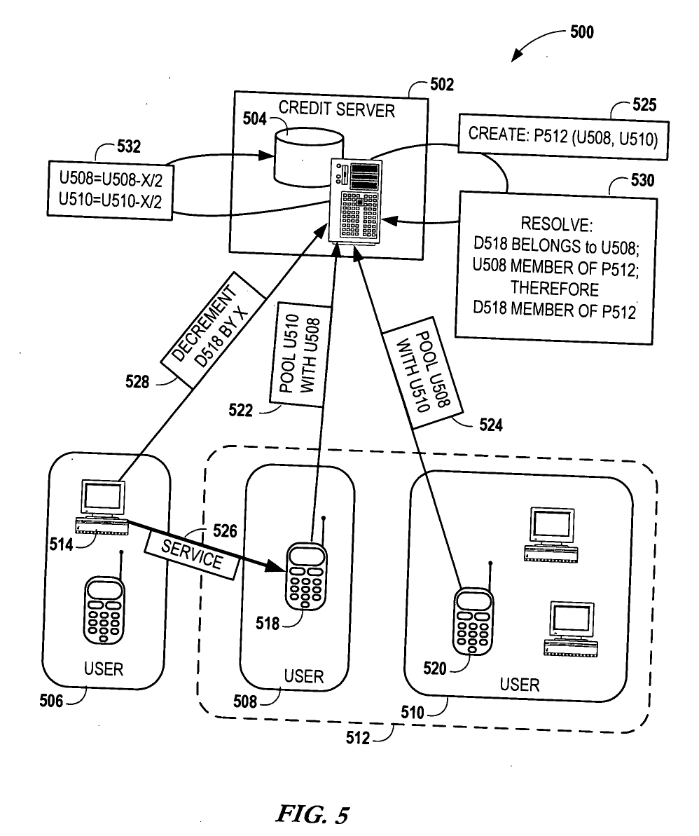

In FIG. 5, a block diagram illustrates a scenario involving credit pooling in a P2P network 500 according to an embodiment of the invention. As with the other scenarios, a credit server 502 maintains the credit data of the network, such as via a database 504. This scenario involves three users 506, 508, 510, each of whom may have one or devices capable of joining the network 500. As indicated by the dashed outline 512, users 508 and 510 are pooling their credits to request service from a network device, such as computer 514 of user 506.

The users 508, 510 may decide to pool their credits permanently (e.g., users 508, 510 enter into a permanent business or personal relationship), temporarily in time or space, to accomplish a particular task of indeterminate duration, etc. Both users 508 and 510 may inform the server 502 (e.g., via respective devices 518, 520) to pool their credits as indicated by messages 522, 524, which are then used to create 525 the pool. These pooling requests 522, 524 may cause all of the devices of users 508, 510 to be included in the pooling arrangement, or only a subset (e.g., devices 518, 520). The messages 522, 524 may also indicated what policy to follow in updating credits to users 508, 510 (and in some cases to their respective devices) when the pool credit is changing. Alternate mechanisms besides dual requests 522, 524 may be used to form, update, or delete pools. For example, one of the user devices 518, 520 could request the pool be formed, and a confirmation from the other of the devices 518, 520 and/or users 508, 510 is required before the server 502 creates 525 the pool.

After the pool is created 525, device 518 requests a service from device 514. Device 514 queries (not shown) the credit server after it has received the service request from peer device 518. In response to the query, the credit server 502 uses the sum of credits of the pool of users 508, 510 instead of the just the credit of the requesting user 508 and/or device 518. If the credit balance is positive (or satisfies some other criteria), device 514 will provide the requested service 526 to device 518. In response to the service 526, device 514 informs the credit server 502 to decrement credit of device 518 by the amount and quality of the received service. In response, the credit server 502 resolves 530, what, if any, user, groups or pools the device 518 may belong to. It will be appreciated that the decrement request 528 may include references to users, groups, and/or pools as well, thus changing the nature of the resolution 530, or eliminating the need for resolution 530.

Although not shown, typically device 518 will send a reciprocal request to the server 502 to increase the credits of device 514 in return for the service 526. The credit server 502 verifies that quantities suggested by devices 514, 518 match, and if the quantities match the server 502 updates its database 504. The credit is added to device 514 and/or user 506 in the normal fashion. However, the credit decrement for device 518 is divided between users 508, 510, as indicated by update 532. Note that the update 532 indicates that users 508 and 510 are equally sharing the loss of credit. The users 508, 510 may agree to an equal or unequal division of any credits gained, or the distribution of credit between users may handled differently based on whether the transaction is an increment or decrement.

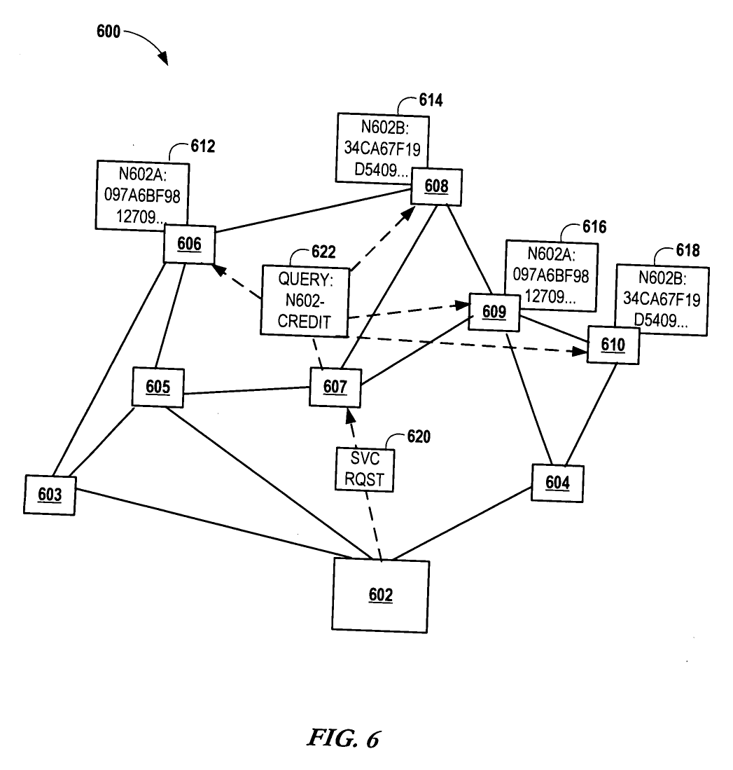

In the previous examples, an authoritative credit service tracks and verifies credits added, subtracted, transferred, etc., by peers of a P2P network. An authoritative entity has many advantages, including enabling strong enforcement of policies, high availability, easy discovery, etc. However, the need for centralized servers is seen as undesirable in many P2P implementations. There are financial costs and other risks associated with running a well-known and publicly addressable server. Further, such servers act as a central point of attack (e.g., denial of service attacks) for those who might attempt to disrupt a P2P network. In FIG. 6, a block diagram illustrates a distributed credit tracking scheme for a P2P network 600 according to an embodiment of the invention.

In the examples of FIG. 6, credits associated with node 602 are maintained by other nodes 603-610 of the P2P network 600. In this illustration, data segments 612, 614, 616, 618 are stored at nodes 606, 608, 609, and 610 respectively. The data segments 612, 614, 616, 618 may be used, either alone or in combination, to track credits associated with node 602. The choice of nodes 606, 608, 609, 610 to store the segments 612, 614, 616, 618 may be randomly or arbitrarily made. In other arrangements, data or structures of the network 600 may dictate which nodes are assigned to store particular portions of credit tracking data. For example, such features as “within x hops from node 602,” “more than y hops from node 602,” “nodes not in IP network aa.bb.cc.00/24,” etc., may dictate which nodes will store data.

The data segments 612, 614, 616, 618 contain complete or partial data that reflects a current credit balance of node 602. For example, the data segments 612 and 616 are shown as identical/redundant, as are segments 614 and 618. The non-redundant segments (e.g., 612 and 614) may be combined to form the actual credit record, thereby preventing a single node from performing an unauthorized alteration on its own stored data. Similarly, redundancy may be used to ensure data has not been tampered with, such that at least two matching records from different nodes must be found before the data is trusted. Further, redundancy may be needed because it may be assumed that nodes may join and leave the network 600 at will, and therefore redundancy may be needed to ensure availability of the data on the network 600.

In some implementations, the distributed credit data may be accessed using query mechanisms that are part of the normal discovery protocols of the network 600. For example, if node 602 sends a request 620 to node 607 for a service, node 607 will send a specially formed distributed query 622 to other nodes to determine the credits currently allocated to node 602. The results of the query 622 may contain enough data so that credit balances may be evaluated, or additional data retrievals may be needed in response to the query results. The data segments 612, 614, 616, 618 may be added, deleted, and/or updated by distributed query protocols of the network, or by some other network mechanisms. The updates may require that, for each credit transfer that results from a service provision, a reciprocal change must also be communicated before nodes will update their data segments.

Generally, in order to be trustworthy, the peer nodes 602-610 may need some criteria to evaluate trustworthiness of the distributed data. For example, a single node may not be considered trustworthy, but if data can be verified at some plurality of nodes, then it may be sufficiently trustworthy for purposes of credit management. Other features, such as public-private key encryption may be used to ensure that a node cannot modify its own credits.

In a distributed credit-tracking scheme such as shown in FIG. 6, associated nodes (e.g., multiple devices having common ownership) may require a way to ensure that commonly accumulated credits are available to entities associated with nodes. Where the credit-tracking scheme uses public-private key encryption, the associated devices may share the same private key, such that credits may be tracked independent of a device ID. In other arrangements, an explicit association between nodes may be required for each credit transaction, and such association may be verified by a challenge-response protocol to any nodes affected by the association.

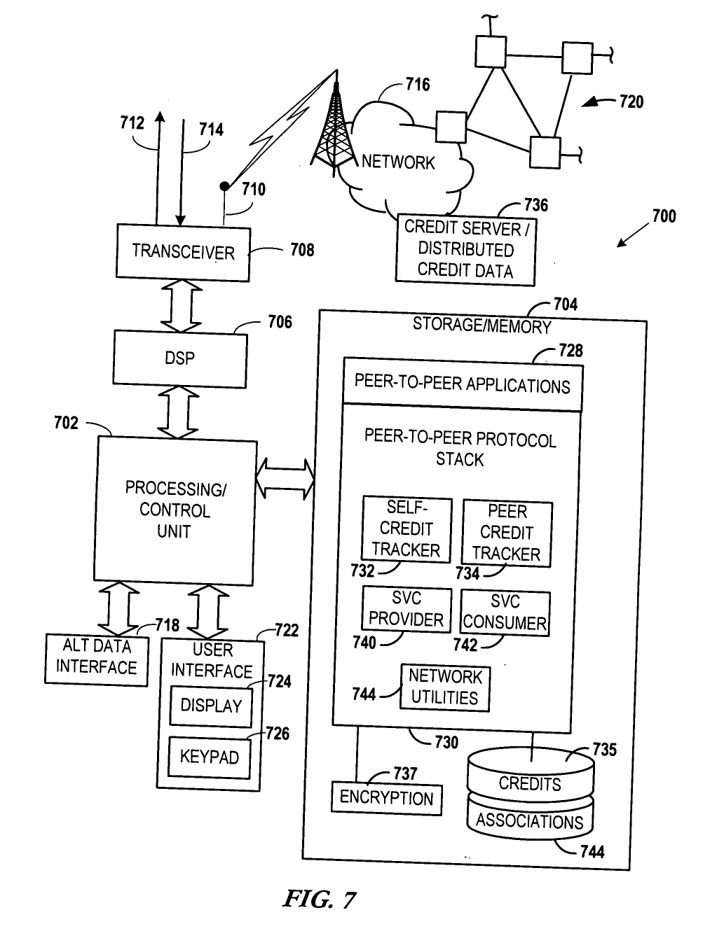

Many types of apparatuses may be able participate in P2P networks using credit schemes as described herein. Mobile devices are particularly useful in this role. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The incoming and outgoing radio signals 712, 714 are used to communicate with a mobile service provider network 716. The network 716 may include any voice and data communications infrastructure known in the art, including CDMA, W-CDMA, GSM, EDGE, etc. The network 716 typically provides access to traditional landline data infrastructures, including IP networks such as the Internet. The mobile computing arrangement 700 may also includes an alternate network/data interface 718 capable of accessing a local network (not shown). The alternate data interface 718 may incorporate combinations of I/O and network standards such as USB, Bluetooth, Ethernet, 802.11 Wi-Fi, IRDA, etc.

The processor 702 is also coupled to user-interface elements 722 associated with the mobile terminal. The user-interface 722 of the mobile terminal may include, for example, a display 724 such as a liquid crystal display. Other user-interface mechanisms may be included in the interface 722, such as keypads 726, speakers, microphones, voice commands, switches, touch pad/screen, graphical user interface using a pointing device, trackball, joystick, etc. These and other user-interface components are coupled to the processor 702 as is known in the art.

The program storage/memory 704 typically includes operating systems and programs for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 704 of the mobile computing arrangement 700 may also include software modules for performing functions according to embodiments of the present invention.

In particular, the program storage/memory 704 may include applications 728 capable of interacting with nodes of a P2P network 720 that is accessible via network 716. Such interactions may also be possible with peers on a short-range network, such as via alternate interface 718. The applications 728 interact with P2P network(s) 720 via a protocol stack 730. The protocol stack 730 may be integrated within each of the applications 728, and/or be a standalone service of the arrangement 700 that is usable by multiple applications 728.

The protocol stack 730 may provide the methods, states, functions, data, and other interactions needed to communicate via the P2P network 720. For example, the protocol stack 730 may handle transactions such as network discovery, joining a network, service discovery, query, upload, download, discovery of P2P metadata, etc. Another function of the protocol stack 730 is represented by credit trackers 732 and 734. The self credit tracker 732 contains the logic needed by the arrangement 700 in order to determined whether the device should gain or lose credits for a particular transaction in which the arrangement 700 itself participates. The peer credit tracker 734 may also track credits for a particular transaction in which the arrangement 700 itself participates, however the credits gained/lost are tracked for another peer of the network 720.

The peer credit tracker 734 may also track credits for transactions in which the arrangement 700 did not participate. For example, where the network 720 uses a distributed credit tracking scheme, the arrangement 700 may need to store data for authenticating some number of other transactions on the P2P network 720. As such, the arrangement 700 is acting as a disinterested party that can verify previous transactions that may have been verified by the parties who took part in the transaction. Generally, the network 720 has some standard way of tracking credits, as represented by credit server/distributed credit data 736. The credit trackers 732, 734 may be able to interact with one or more different types of crediting arrangements 736 unique to the particular P2P network 720. The credit trackers 732, 734 may temporarily or persistently store relevant credit data in a local credit database 735. The credit trackers 732, 734 may also rely on authentication and verification that uses encryption, as represented by encryption module 737.

The credit trackers 732, 734 will typically interface with service provider components 740 and service consumer components 742 in order to determine whether credits should be increased or decreased for a particular transaction. The services provided/consumed via these components 740, 742 may be any type of computing service (e.g., data storage, network bandwidth, CPU processing, routing). The service modules 740, 742 may use a standard set of network utilities 744 for such purposes. The network utilities 744 may include such functions as DNS lookups, network status monitoring, etc. In other arrangements, the network utilities 744 may include the capability to communicate with other nodes (e.g., peers) regarding credit pooling, association, transfer, etc. For example, the utilities 744 may facilitate a push by (e.g. SMS, email, instant message, MMS) to offer new capacity, and network messages such as SMS or email may provide the ability (e.g., via an executable or non-executable embedded data object,) to automatically facilitate the credit transfer/pooling. The utilities 744 may also facilitate receiving and processing such network messages to enable the transfer/pooling on the receiver's end.

The arrangement 700 may be associated with another device of the P2P network 720 at least for purposes of sharing, transferring, or otherwise using credits in a way that does not involve the typical provision and use of services for which the credits are intended. These associations may be stored as data 744 on the local memory 700, and the credit server/distributed credit data 736 will have provisions for dealing with the associations 744. The credit trackers 732, 734 may also have provisions for dealing with the devices own associations 744, as well as associations of other devices of the P2P network 720. These associations 744 may include the grouping of devices due to common ownership, the addition/subtraction of credits resulting from an out-of-band transaction, etc.

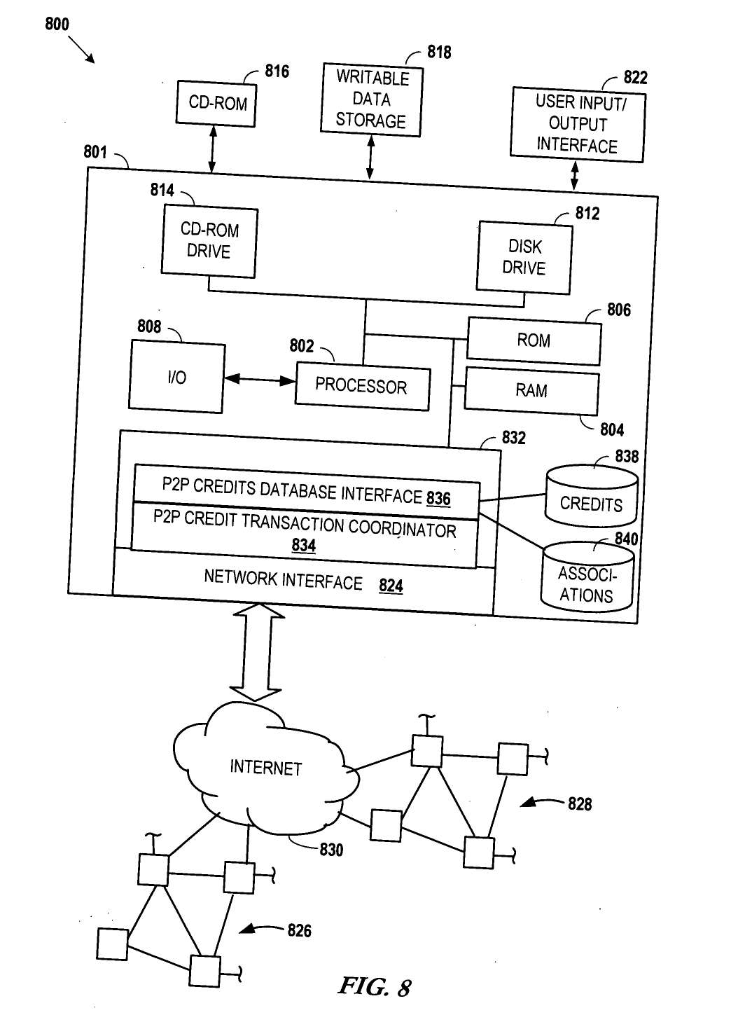

In some arrangements, a P2P network may require that peers individually track credits on behalf of other peers, thus distributing the tracking data among nodes of the network. Such a distributed tracking mechanism also needs a way to identify and deal with associations between different devices or other entities for purposes of sharing and transferring credits. In spite of the highly distributed nature of P2P, some implementations involve a central server to help content discovery and coordinate content delivery in a more optimal way. A credit system as described herein can also be implemented on this central server. A credit server can provide authoritative credit data, as well as verifying and recording credit transactions. In reference now to FIG. 8, a block diagram illustrates an example credit server 800 according to an embodiment of the invention. The credit server 800 includes a computing arrangement 801. The computing arrangement 801 may include custom or general-purpose electronic components. The computing arrangement 801 includes a central processor (CPU) 802 that may be coupled to random access memory (RAM) 804 and/or read-only memory (ROM) 806. The ROM 806 may include various types of storage media, such as programmable ROM (PROM), erasable PROM (EPROM), etc. The processor 802 may communicate with other internal and external components through input/output (I/O) circuitry 808. The processor 802 carries out a variety of functions as is known in the art, as dictated by software and/or firmware instructions.

The computing arrangement 801 may include one or more data storage devices, including disk drives 812, CD-ROM drives 814, and other hardware capable of reading and/or storing information such as DVD, etc. In one embodiment, software for carrying out the operations in accordance with the present invention may be stored and distributed on a CD-ROM 816, writable data storage media 818 or other form of media capable of portably storing information, including magnetic media, flash memory, etc. These storage media may be inserted into, and read by, devices such as the CD-ROM drive 814, the disk drive 812, I/O ports 808, etc. The software may also be transmitted to computing arrangement 801 via data signals, such as being downloaded electronically via a network, such as the Internet 830. The computing arrangement 801 may be coupled to a user input/output interface 822 for user interaction. The user input/output interface 822 may include apparatus such as a mouse, keyboard, microphone, touch pad, touch screen, voice-recognition system, monitor, LED display, LCD display, etc.

The computing arrangement 801 may be coupled to other computing devices via networks. In particular, the computing arrangement includes a network interface 824 for communicating with networks, such as represented by the Internet 830. The network interface 824 may include a combination of hardware and software components, including media access circuitry, drivers, programs, and protocol modules. The Internet 830 (or other private or public network) may support the formation of P2P networks 826, 828 Nodes of the P2P networks 826, 828 may access the credit server 800 via the network interface 824 for purposes of managing credit data related to service usage and consumption on the respective networks 826, 828.

The computing arrangement 801 includes processor executable instructions 832 for carrying out credit management tasks of the computing arrangement 801. These instructions 832 may include a P2P credit transaction coordinator 834 that interfaces with the P2P networks 826, 828. The transaction coordinator 834 generally uses common protocols of the P2P networks 826, 828 to increment or decrement credits based on peer interaction. The credit updates are stored/applied to a credit database 838 by way of a database interface 836. The database 838 may track peer credits at varying levels of granularity (e.g., application, device, user, organization, etc.).

The transaction coordinator 834 may apply rules required of the networks 826, 828 before committing any credit transactions to the database 838, such as enforcing zero-sum rules for in-band transactions. The credit update protocols used by the network nodes may also require verification by two network nodes for any credit transfer, or some other authentication source may be referred to. One of those alternate authentication sources is represented by the associations database 840. The associations database 840 can be used to increment or decrement credits based on an alternate mechanism, such as association between devices or out-of-band credit transfer. The transaction coordinator 834 may access the associations database 840 via the database interface 836 when processing credit transactions, and may also process the creation, verification, modification and deletion of particular association data.

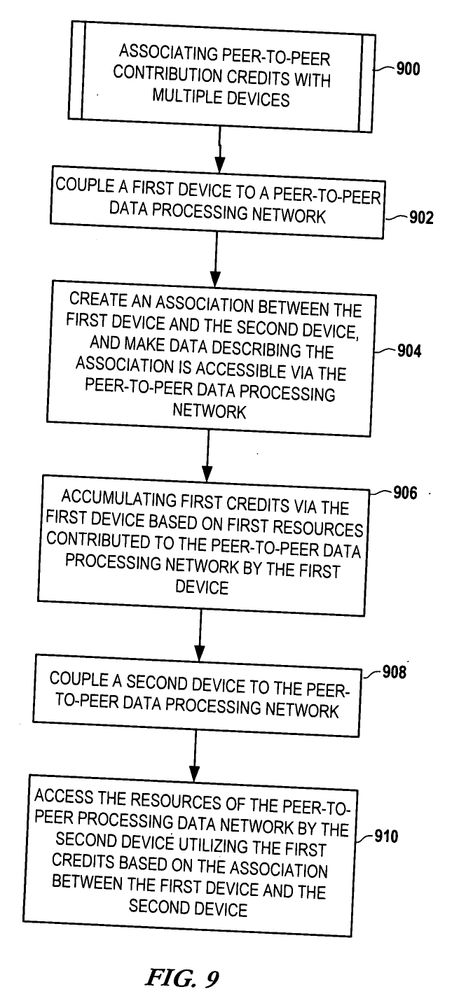

In reference now to FIG. 9, a flowchart illustrates a procedure 900 for using P2P credits according to an embodiment of the invention. A first device is coupled 902 to a peer-to-peer data processing network. Resources of the peer-to-peer data processing network are allocated based on credits, and the credits are earned based on contribution of resources to the peer-to-peer data processing network. An association is created 904 between the first device and the second device, and data used to enforce the association is accessible via the peer-to-peer data processing network. This association data may be explicit or implicit. For example, an explicit association might assert a rule such as “devices A, B, and C belong to user U and share credits equally.” Implicit association data may include, for example, a situation where credits are associated with a secret key as opposed to devices or users. Thus credits would be allocated based on the key no matter what devices use credits associated with the key.

First credits are accumulated 906 via the first device based on first resources contributed to the peer-to-peer data processing network by the first device. The second device is coupled 908 to the peer-to-peer data processing network. The second device then accesses 910 the resources of the peer-to-peer processing data network utilizing the first credits based on the association between the first device and the second device.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
coupling a first device to a peer-to-peer data processing network, wherein resources of the peer-to-peer data processing network are allocated based on credits, and wherein the credits are earned based on contribution of resources to the peer-to-peer data processing network;
creating an association between the first device and the second device, wherein data used in enforcing the association is accessible via the peer-to-peer data processing network;
accumulating first credits via the first device based on first resources contributed to the peer-to-peer data processing network by the first device;
coupling the second device to the peer-to-peer data processing network; and
accessing the resources of the peer-to-peer processing data network by the second device utilizing the first credits based on the association between the first device and the second device.

2. The method of claim 1, further comprising communicating the association between the first device and the second device to peers of the peer-to-peer data processing network.

3. The method of claim 1, wherein the association between the first and second devices comprises common ownership of the first and second devices.

4. The method of claim 3, wherein the first device comprises a non-mobile device and the second device comprises a mobile device.

5. The method of claim 1, wherein the association between the first and second devices comprises an transfer of valuable consideration from an owner of the second device to an owner of the first device.

6. The method of claim 5, wherein the transfer of valuable consideration comprises a monetary transfer.

7. The method of claim 5, wherein the transfer of value comprises the acceptance of advertisement by the owner of the second device

6. The method of claim 1, further comprising tracking the accumulated credits via a central entity.

8. The method of claim 1, further comprising tracking the accumulated credits among peers of the peer-to-peer data processing network that were not involved in the access of the resources by the second device.

9. The method of claim 1, wherein the peer-to-peer data processing network comprises a distributed data distribution network, and wherein the contribution of resources to the peer-to-peer data processing network comprises transfers of data from peers of the peer-to-peer data processing network to other peers of the peer-to-peer data processing network.

10. The method of claim 9, wherein the contribution of resources to the peer-to-peer data processing network comprises transcoding of media on behalf of the other peers of the peer-to-peer data processing network.

11. The method of claim 1, wherein the peer-to-peer data processing network comprises a distributed search network, and wherein the contribution of resources to the peer-to-peer data processing network comprises a quantity of uploadable items made searchable by peers of the peer-to-peer data processing network.

12. The method of claim 1, wherein the contribution of resources to the peer-to-peer data processing network further comprises a quantity of the uploadable items uploaded to peers of the peer-to-peer data processing network.

13. The method of claim 1, wherein the contribution of resources to the peer-to-peer data processing network comprises transcoding of media on behalf of other peers of the peer-to-peer data processing network.

14. An apparatus comprising:
a network interface capable of communicating via a peer-to-peer data processing network, wherein resources of the peer-to-peer processing network are allocated based on credits, and wherein the credits are earned based on contribution of resources to the peer-to-peer data processing network;
a processor coupled to the network interface; and
memory coupled to the processor, the memory including instructions that cause the processor to,
connect to the peer-to-peer data processing network;
determine an association between the apparatus and a peer device of the peer-to-peer data processing network; and
utilize credits of the peer device to access resources of the peer-to-peer processing network, wherein the credits are made available based on the association between the apparatus and the peer device.

15. The apparatus of claim 14, wherein the memory includes instructions that cause the processor to facilitate transfer of valuable consideration between an owner of the apparatus and an owner of the peer device, wherein the association is created based on the transfer of valuable consideration.

16. The apparatus of claim 14, wherein the association between the apparatus and a peer device comprises common ownership of the apparatus and the peer device.

17. The apparatus of claim 16, wherein the apparatus comprises a mobile device and the peer device comprises a non-mobile computing device.

18. The apparatus of claim 14, wherein the memory includes instructions that cause the processor to facilitate allowing peers of the peer-to-peer network to confirm the association.

19. A computer-readable storage medium having instructions stored thereon which are executable by an apparatus capable of being coupled to a peer-to-peer data processing network, wherein resources of the peer-to-peer processing network are allocated based on credits, and wherein the credits are earned based on contribution of resources to the peer-to-peer data processing network, the instructions executable for performing steps comprising:
connecting to the peer-to-peer data processing network;
asserting an association between the apparatus and a peer device of the peer-to-peer data processing network; and
utilizing credits of the peer device to access resources of the peer-to-peer processing network, wherein the credits are made available based on the association between the apparatus and the peer device.

20. A system comprising:
means for tracking credits assigned to peers of a peer-to-peer data processing network, wherein the credits are earned based on contribution of resources to the peer-to-peer data processing network;
a first peer device capable of being coupled to the peer-to-peer data processing network, the first peer device comprising means for accumulating first credits based on first resources contributed to the peer-to-peer data processing network by the first peer device;
a second peer device capable of being coupled to the peer-to-peer data processing network, the second peer device comprising means for utilizing the first credits based on an association between the first peer device and the second peer device;
means for persistently storing association data that describes the association between the first peer device and the second peer device; and
means for making the association data available to the peers of the peer-to-peer data processing network.

21. The system of claim 20, further comprising means for transferring valuable consideration from an owner of the second device to an owner of the first device, wherein the association data is created based on the transfer of the valuable consideration.
